(19) United States
(12) Patent Application Publication
(10) Pub. No.: US 2010/0294256 A1
(43) Pub. Date: Nov. 25, 2010

(54) DIAMOND TOOL AND METHOD FOR MANUFACTURING SEGMENT THEREOF

(75) Inventors: Hyun Woo Lee, Incheon (KR); Jong Hwan Park, Seoul (KR); Bu Kun Park, Bucheon-si (KR); Jae Wook Lim, Chungju-si (KR)

Correspondence Address: SEED INTELLECTUAL PROPERTY LAW GROUP PLLC, 701 FIFTH AVE, SUITE 5400, SEATTLE, WA, 98104, US

(73) Assignee: SHINHAN DIAMOND IND. CO., LTD., Incheon (KR)

(21) Appl. No.: 12/515,273

(22) PCT Filed: Apr. 24, 2007
(86) PCT No.: PCT/KR07/01992

§ 371 Date: Aug. 6, 2010

(30) Foreign Application Priority Data
Nov. 16, 2006 (KR) 10-2006-0113541

(51) Int. Cl. B23D 61/02; B28D 1/04; B24D 18/00

(52) U.S. Cl. 125/15; 51/308; 451/548

(57) ABSTRACT

The present invention relates to a diamond tool for cutting a workpiece. An object of the present invention is to provide a diamond tool, wherein a wear-resistant region is formed in a connection portion between a segment and a shank of the diamond tool to prevent an under-cut phenomenon, to extend the service life of the diamond tool and to improve cutting quality due to easy discharge of cut chips. A diamond tool of the present invention for achieving the object has a cutting segment that contains a plurality of diamond granules and is attached to an outer peripheral surface of a shank, wherein the segment comprises an auxiliary cutting portion that has a thickness identical with that of the shank and a height and is attached to the shank; and a primary cutting portion that is integrally formed on the top of the auxiliary cutting portion and has a thickness larger than that of the auxiliary cutting portion.

### BACKGROUND

1. Technical Field

The present invention relates to a diamond tool for cutting a work piece and a method for manufacturing a segment of the diamond tool, and more particularly, to a diamond tool in which a connection portion with a segment is prevented from being worn by cut chips generated upon cutting of a work piece, and a method for manufacturing a segment of the diamond tool.

2. Description of the Related Art

FIG. 1 is a plan view showing a typical wheel-type diamond tool, and FIGS. 2(a) and (b) are a perspective view and a sectional view showing a segment of a conventional diamond tool, respectively.

As shown in FIGS. 1 and 2, the diamond tool 10 is generally a tool for cutting or grinding a surface of a work piece. The diamond tool 10 cuts or grinds the work piece while reciprocating or rotating at a high speed. The diamond tool 10, which cuts or grinds a work piece while rotating at a high speed in such a manner, includes a shank 12 that takes the shape of a wheel or disk to machine an inner diameter or inner surface or an outer or inner race of a work piece and is to be coupled to a grinding machine. In addition, the shank 12 has slots with a desired length which are formed from an outer periphery toward a central axis of the shank 12, and segments 14 responsible for substantial cutting operations are attached between adjacent ones of the slots.

Each of the segments 14 comprises a bonding portion 16 formed by sintering a paste type binder, and diamond granules 15 irregularly dispersed in the bonding portion 16. A mixture of the binder and the diamond granules 15 are placed in a mold with a predetermined shape and then subjected to heat and pressure so that the mixture can be sintered and dried.

Meanwhile, in case of the conventional diamond tool 10, the segment 14 is formed to have a thickness larger than that of the shank 12. If the thickness of the segment 14 is larger than that of the shank 12 in such a manner, cut chips or heat can be easily discharged or dissipated and friction between a work piece and the shank 12 can be reduced.

Cut chips generated during a cutting operation of the diamond tool 10 are discharged mostly through the slots. At this time, during the discharge of the cut chips, the cut chips pass through between the segment 14 and a stepped portion (portion A) of the shank 12. Thus, an under-cut phenomenon in which a bonded region between the segment 14 and the shank 12 is worn out.

If the diamond tool 10 is subjected to wear due to the under-cut phenomenon, the bonding area of the bonded region between the segment 14 and the shank 12 is reduced as shown in FIG. 3. Consequently, there is a problem in that the segment 14 is separated from the shank 12. This separation of the segment 14 may lead to a safety accident to an operator during a cutting operation. In addition, if the under-cut phenomenon occurs in the diamond tool 10, it acts as an obstacle to a normal operation of the tool. Therefore, there is a problem in that the diamond tool 10 should be replaced.

Thus, in order to avoid the under-cut phenomenon in the diamond tool 10, there has been conventionally proposed a technique in which a super hard block 20 or another segment 30 having the same thickness as that of the segment 14 is attached to a front side of the segment 14 and the slot with respect to a cutting direction, as shown in FIGS. 4 and 5. The super hard block 20 or another segment 30 has wear resistance and also disperses discharge passages of cut chips, thereby effectively avoiding the under-cut phenomenon.

However, a conventional process of attaching the super hard block 20 or additional segment 30 to the diamond tool 10 has been manually carried out through laser or brazing bonding. Thus, it is not easy to automate the process, thereby increasing manufacturing-time and disenabling mass production. In addition, since the process of attaching the super hard block 20 or additional segment 30 is carried out at an elevated temperature of 700° C. or more, the diamond granules 15 contained in the segment 14 may be thermally damaged, leading to degradation in the cutting performance of the diamond tool 10.

### BRIEF SUMMARY

According to one of the embodiments of the present invention a diamond tool has a wear-resistant region in a connection portion between a segment and a shank of the diamond tool. One advantage of this structure is to prevent an under-cut phenomenon. Further advantages are to extend the service life of the diamond tool and to improve cutting quality due to easy discharge of cut chips. A method for manufacturing a segment of the diamond tool is also disclosed.

One embodiment of the diamond tool of the present invention for achieving the object has a cutting segment that contains a plurality of diamond granules and is attached to an outer peripheral surface of a shank, wherein the segment comprises an auxiliary cutting portion that has a thickness identical with that of the shank and a height and is attached to the shank; and a primary cutting portion that is integrally formed on the top of the auxiliary cutting portion and has a thickness larger than that of the auxiliary cutting portion.

The auxiliary and primary cutting portions may be connected to each other in a stepped fashion. Further, a connection surface between the auxiliary and primary cutting portions may comprise a curved surface or a slant surface. The height of the auxiliary cutting portion may be in a range of 0.8 to 3 mm. A difference between the thicknesses of lower ends of the auxiliary and primary cutting portions may be not less than 0.2 mm. Moreover, the auxiliary cutting portion may be provided, at an outer side thereof, with a wear region having a height and a thickness to be flush with an outer surface of the primary cutting portion. The wear region may include a region without diamond granules. Here, the height of the wear region may be in a range of 0.8 to 3 mm.

A method for manufacturing a segment of a diamond tool according to one embodiment of the present invention for achieving the object is a method for manufacturing a segment including an auxiliary cutting portion to be attached to a shank and a primary cutting portion integrally formed on the top of the auxiliary cutting portion, wherein the method comprises the steps of mixing diamond granules with a binder; forming a segment pre-form by press-molding the mixture of diamond granules and binder within molds having a predetermined shape so that the auxiliary cutting portion has a thickness corresponding to that of the shank and the primary cutting portion has a thickness larger than that of the auxiliary cutting portion; and sintering the segment pre-form to obtain a final product.

Each of the molds may have a lower end protruding in a stepped fashion. Alternatively, each of the molds may have a lower end protruding in a curved or slant fashion.

A method for manufacturing a segment of a diamond tool according to another aspect of the present invention provides for an auxiliary cutting portion to be attached to a shank and a primary cutting portion integrally formed on the top of the auxiliary cutting portion. The method comprises the steps of preparing a segment pre-form such that diamond granules arranged in a binder constituting the auxiliary cutting portion are arranged to establish a thickness corresponding to that of the shank, and diamond granules arranged in a binder constituting the primary cutting portion are arranged to establish a thickness larger than that of the auxiliary cutting portion; and sintering the segment pre-form to obtain a final product.

The step of arranging the diamond granules may comprise arranging the diamond granules to have a stepped portion corresponding to the auxiliary and primary cutting portions. Alternatively, the step of arranging the diamond granules may comprise arranging the diamond granules such that the auxiliary and primary cutting portions are connected to each other in a curved or slant fashion. In addition, the diamond granules may be distributed uniformly or non-uniformly.

### BRIEF DESCRIPTION OF THE SEVERAL VIEWS OF THE DRAWINGS

The above and other objects, features and advantages of the present invention will become apparent from the following description of preferred embodiments given in conjunction with the accompanying drawings, in which:

FIG. 1 is a plan view showing a typical wheel-type diamond tool;

FIGS. 2(a) and (b) are views showing a segment of a conventional diamond tool;

FIG. 3 is a view showing changes in a segment connection region of a conventional diamond tool as the diamond tool is used;

FIGS. 4 and 5 are plan views partially showing other conventional diamond tools;

FIG. 6 is a front view of a diamond tool according to one embodiment of the present invention;

FIG. 7 is an enlarged perspective view of a segment of the diamond tool according to the present invention;

FIG. 8 is an enlarged sectional view of the segment of the diamond tool according to one embodiment of the present invention;

FIGS. 9(a) and (b) are enlarged sectional views showing segments of diamond tools according to other embodiments of the present invention;

FIGS. 10(a) and (b) are sectional views showing a wear region in a segment of a diamond tool according to one embodiment of the present invention and a state where the wear region is worn out, respectively;

FIGS. 11(a) to (e) are views illustrating processes of a method for manufacturing a segment of a diamond tool according to an embodiment of the present invention; and

FIG. 12 is a perspective view showing a virtually exploded state of a segment of a diamond tool according to one embodiment of the present invention.

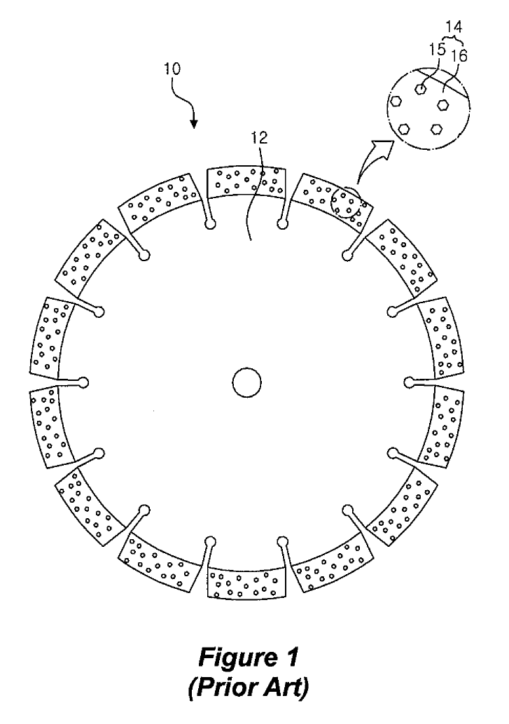

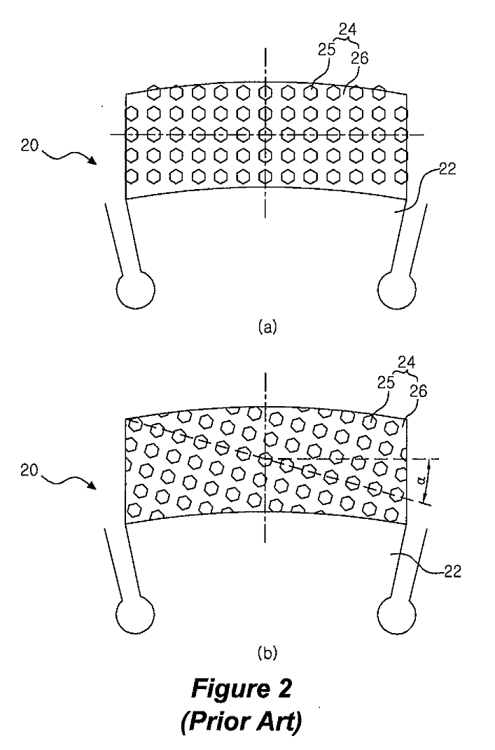

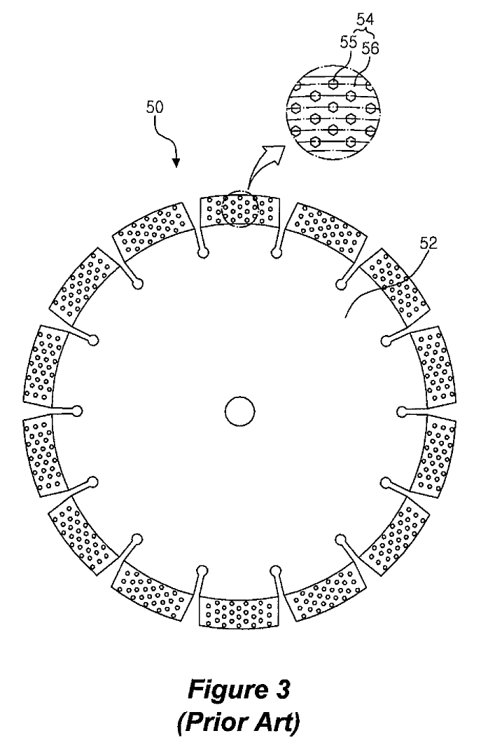

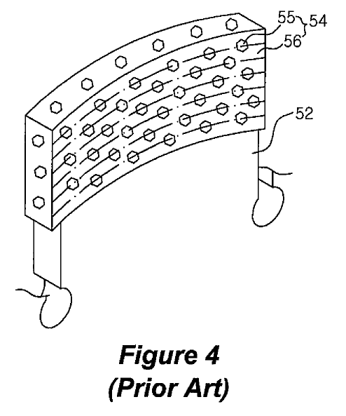

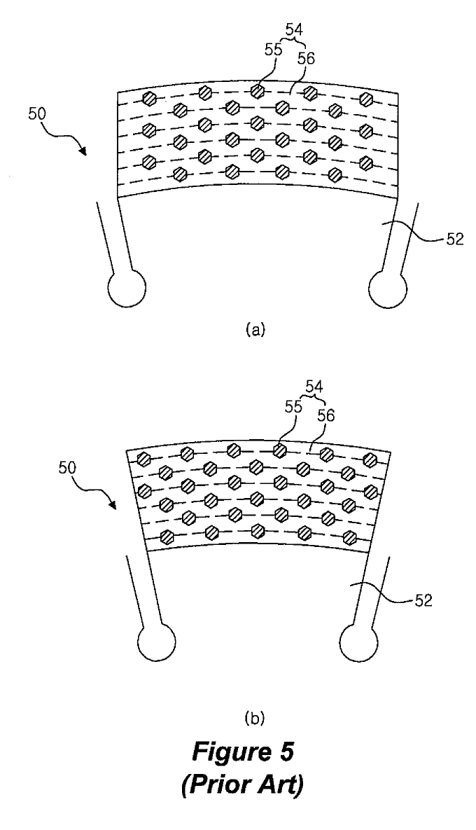

### DETAILED DESCRIPTION

Hereinafter, preferred embodiments of the present invention will be described in detail with reference to the accompanying drawings.

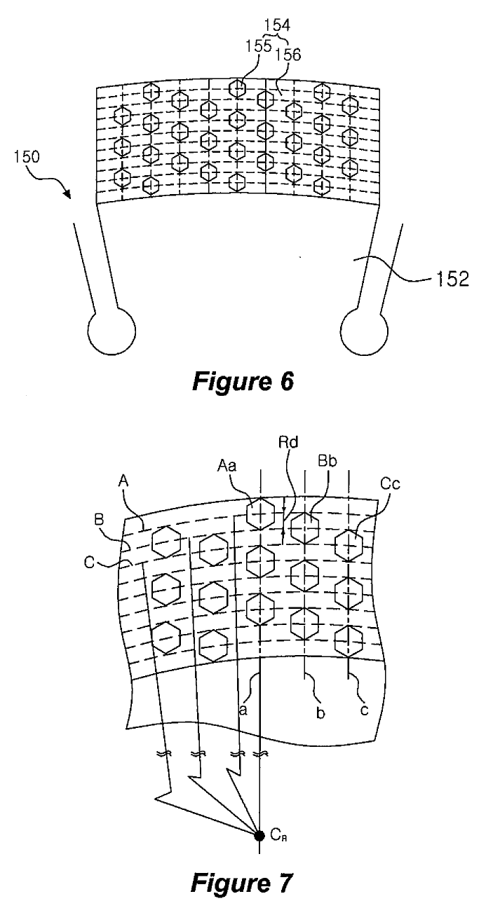

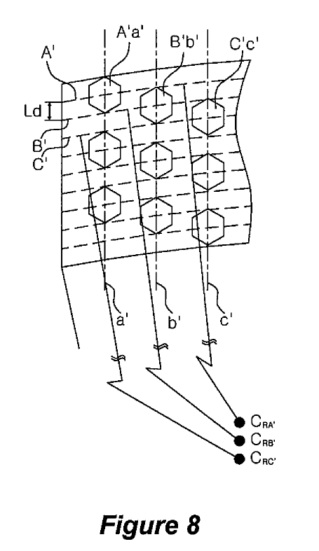

FIG. 6 is a front view of a diamond tool according to one embodiment of the present invention, and FIGS. 7 and 8 are an enlarged perspective view and an enlarged sectional view of a segment of the diamond tool according to one embodiment of the present invention, respectively.

As shown in FIGS. 6 to 8, the diamond tool 50 of one embodiment of the present invention includes a shank 52 that takes the shape of a wheel or disk and is to be coupled to a grinding apparatus. The shank 52 has slots 58 with a desired length which are formed from an outer periphery toward a central axis of the shank. In addition, segments 54 of which comprises a plurality of diamond granules 55 and a bonding portion 56 for holding the diamond granules 55 are attached between adjacent ones of the slots 58 of the shank 52. Here, the segments 54 may be formed separately from the shank 54 and then attached to the shank 54, or may be formed directly on the surface of the shank 52.

Preferably, the segments 54 are attached to an outer peripheral surface of the shank 53 by means of brazing.

Meanwhile, an inner peripheral surface of each of the segments 54 has the same curvature as that of the outer peripheral surface of the shank 52. The entire shape defined by the outer peripheral surfaces of the segments is generally a circle about the central axis of the shank 52.

Furthermore, the segment 54 may be formed such that a front face thereof in charge of substantial cutting is in parallel with a rear face thereof, or such that the faces have slopes extending from the slots 58.

The segment 54 includes an auxiliary cutting portion 54a attached to the shank 53 and a primary cutting portion 54b integrally formed on the auxiliary cutting portion 54a.

The auxiliary cutting portion 54a is formed to have the same thickness as that of the shank 53, and the primary cutting portion 54b is formed to have a thickness larger than that of the auxiliary cutting portion 54a.

In addition, the auxiliary cutting portion 54a and the primary cutting portion 54b are connected to each other such that a connection portion (portion B) (FIG. 8) therebetween is stepped. Cut chips generated during machining of a work piece are discharged through the stepped space between the auxiliary cutting portion 54a and the primary cutting portion 54b. At this time, the auxiliary cutting portion 54a has higher wear resistance than the cut chips, so that an under-cut phenomenon does not occur.

The auxiliary cutting portion 54a is formed to have a predetermined height from a portion thereof connected to the shank 52 (portion C) (FIG. 8) to the top thereof. Here, it is preferred that the height be determined such that cut chips to be discharged do not come into contact with the shank 52. More preferably, the height H (FIG. 8) of the auxiliary cutting portion 54a may be in a range of 0.8 to 3 mm, and may vary with an outer diameter of the shank 52.

In addition, the difference in the thicknesses of lower ends of the auxiliary cutting portion 54a and the primary cutting portion 54b, i.e., the thickness of the stepped portion D (FIG. 8), is preferably not less than 0.2 mm. Thus, the cut-chips can be quickly discharged and the shank 52 can be prevented from coming into contact with a work piece.

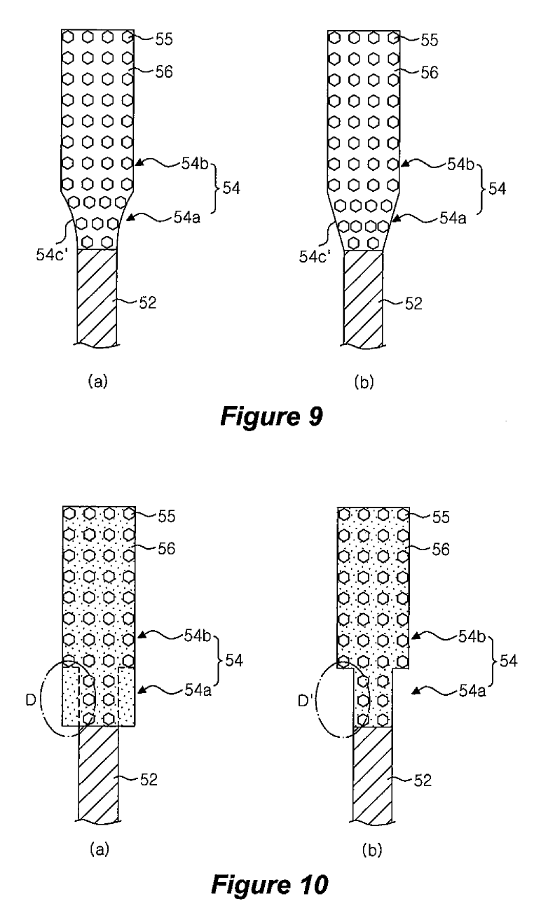

Although the auxiliary cutting portion 54a is illustrated to be stepped from the primary cutting portion 54b in this embodiment, it may be formed in various different forms. As one example, a connection surface between the auxiliary and primary cutting portions may be formed of a curved surface 54c as shown in FIG. 9(a), or a slant surface 54c′ as shown in FIG. 9(b). In this way, the auxiliary and primary cutting portions 54a and 54b are connected to each other smoothly without formation of any notch, leading to improvement in the durability of the auxiliary and primary cutting portions 54a and 54b.

FIGS. 10(a) and (b) are sectional views showing a wear region in a segment of a diamond tool according to one embodiment of the present invention and a state where the wear region is worn out, respectively.

Meanwhile, in order to facilitate manufacture of the segments 54 of the diamond tool 50, a wear region D with a predetermined height may be further formed outside of the auxiliary cutting portion 54a, as shown in FIG. 10(a). At this time, the wear region D is formed to have a thickness to be flush with an outer surface of the primary cutting portion 54b.

Preferably, the wear region may be formed integrally with the auxiliary and primary cutting portions 54a and 54b, and is formed into a region without any diamond granules. Thus, the wear region D becomes a region with lower wear resistance. Due to the lower wear-resistant property, the wear region D is easily worn out by cut chips generated upon cutting of a work piece. If the wear region D has been worn out by the cut chips, the diamond granules 55 of the auxiliary cutting portion 54a are exposed to the outside through a worn portion D′, as shown in FIG. 10(b).

As described above, the wear region D is a region that is easily worn out by cut chips, and the cut chips can be easily discharged through the worn portion D′ produced in the wear region.

Next, a method for manufacturing the segment of the diamond tool according to one embodiment of the present invention constructed as above will be described.

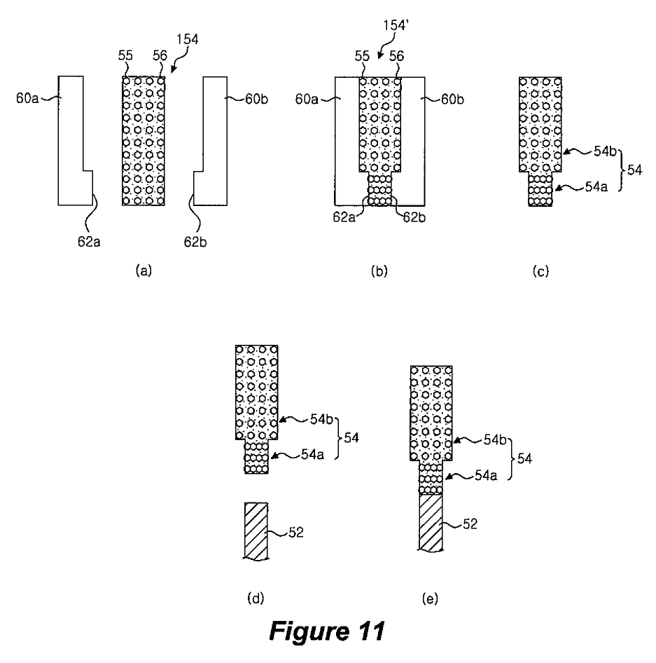

FIGS. 11(a) to (e) are views illustrating processes of a method for manufacturing the segment of the diamond tool according to an embodiment of the present invention. First, as shown in FIG. 11(a), a mixture of the diamond granules 55 and a binder are prepared and then molded into a pre-form 154 having the shape of a general segment. To this end, the segment-shaped pre-form 154 is placed between molds 60a and 60b. Here, the molds 60a and 60b are to form shapes corresponding to the auxiliary and primary cutting portions 54a and 54b. The molds 60a and 60b have laterally symmetrical shapes and are provided in a pair. The molds are provided at their lower ends with stepped protrusions 62a and 62b which are configured to correspond to the shape of the auxiliary cutting portion 54a.

Then, as illustrated in FIG. 11(b), the pre-form 154 is press-formed into the shape of the segment 54, using the mold 60 with the predetermined shape. When the segment-shaped pre-form 154 is pressed from both lateral sides, it is molded into a final segment form 154′.

Thereafter, the molded body formed by the molds 60a and 60b is sintered through a sintering process to manufacture a finished segment 54 as shown in FIG. 11(c). At this time, the binder 16 is removed from the segment 54 during the sintering process.

Therefore, the segment 54 is provided with an auxiliary cutting portion 54a having the same thickness as that of the shank 52, and a primary cutting portion 54b formed on the top of the auxiliary cutting portion 54a and having a thickness lager than that of the auxiliary cutting portion 54a. At this time, the auxiliary cutting portion 54a formed by the molds 60a and 60b has a height H of 0.8 to 3 mm. In addition, it is desirable that the difference in the thicknesses of lower ends of the auxiliary cutting portion 54a and the primary cutting portion 54b, i.e., the thickness of a stepped portion D, is not less than 0.2 mm.

The segment 54 thus molded is attached to the outer peripheral surface of the shank 52 through laser welding or brazing, as illustrated in FIG. 11(d). FIG. 11(e) shows a final diamond tool with the segment 54 attached thereto.

In one embodiment of the present invention, in a case where the modes 60a and 60b have stepped protrusions at their lower ends, the auxiliary and primary cutting portions 54a and 54b can be formed to have the stepped portion therebetween. On the other hand, the shapes of the molds 60a and 60b are not limited to a stepped shape but may be changed into various other shapes. For example, the molds 60a and 60b may be formed to have lower ends protruding curvilinearly or slantly. In the segment 54 formed by the molds 60a and 60b, the primary and auxiliary cutting portions 54a and 54b may be connected to each other through a curved surface or slant surface.

The segment 54 manufactured as above is attached to the outer peripheral surface of the shank 52 by means of laser welding or brazing.

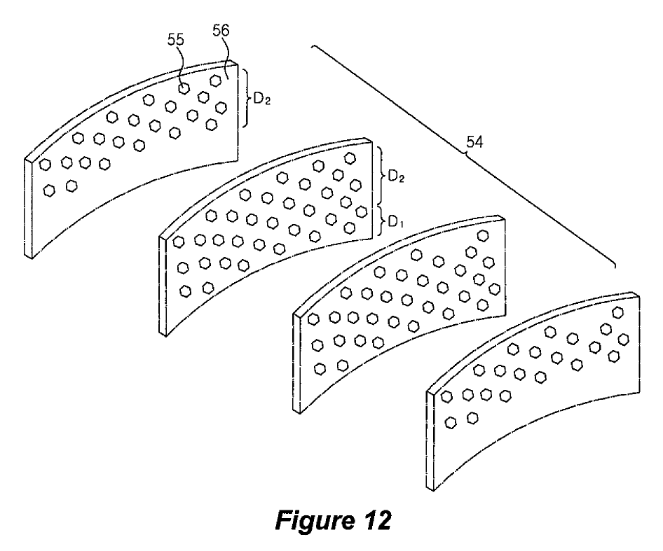

In addition, the segment 54 may be formed through other various methods in addition to the method using the molds 60a and 60b. For example, FIG. 12 is a perspective view showing a virtually exploded state of a segment of a diamond tool according to the present invention.

Referring to FIG. 12, diamond granules 55 are arranged in a bonding portion 56, which is made of a binder, up to a lower end thereof so as to correspond to the shapes of the primary and auxiliary cutting portions 54b and 54a. Then, diamond granules 55 are arranged on the top of the arranged diamond granules 55 and the binder 16 so as to correspond to the shape of the primary cutting portion 54b.

A molded body comprising the bonding portion 56 and the diamond granules 55 may be formed to generally have a rectangular cross section, and the diamond granules 55 arranged therein are patterned to correspond to a primary cutting region D1 and an auxiliary cutting region D2.

When the molded body is prepared, the molded body is sintered to manufacture a final segment 54.

The segment 54 manufactured as above is attached to the outer peripheral surface of the shank 52 through laser welding or brazing.

According to the arranged pattern of the diamond granules 55 in the segment 54, the diamond granules 55 can be arranged in a stepped form corresponding to the auxiliary or primary cutting portion 54a or 54b. Here, in the segment 54, a portion thereof without diamond granules may be easily worn out and thus cut chips generated upon cutting of a work piece can be discharged through the worn region of the segment 54.

Meanwhile, according to the arranged pattern of the diamond granules 55 in the segment 54, a layer of the diamond granules 55 may be arranged in a curved form or in a slant form. Accordingly, upon cutting of a work piece, the portion of the segment without diamond granules is worn out in a curved or slant fashion.

With the diamond tool and the method for manufacturing the segment of the diamond tool according to the present invention constructed as described above, a wear-resistant region is formed in a connection portion between the shank and the segment to improve durability, thereby avoiding an under-cut phenomenon and thus extending the service life of the diamond tool. In addition, since the diamond tool is provided with a discharge passage for cut chips, the cutting performance thereof is further improved. Heat can be discharged through the passage to further improve the durability of the diamond tool. Furthermore, upon manufacture of the segment, molds are used to form the shape of the segment and diamond granules can be arranged in a pre-patterned arrangement. In addition, a portion having lower wear resistance is formed in the segment so that this portion is worn out upon machining of a work piece so as to provide a passage for cut chips, thereby facilitating the manufacture of the segment.

Although the diamond tool and the method for manufacturing the segment of the diamond tool according to the present invention have been described with reference to the accompanying drawings, the present invention is not limited to the aforementioned embodiments and the drawings. It will be apparent to those skilled in the art that various modifications and changes can be made thereto within the scope of the present invention defined by the appended claims. In addition, in the present invention, the diamond granules may be arranged uniformly or non-uniformly according to a pre-programmed pattern. Furthermore, although the binder 16 supplied in the present invention has been illustrated as having a rectangular cross section, this is for the sake of convenience of manufacture thereof. Of course, it is possible to supply a binder having a shape corresponding to the primary and auxiliary cutting portions of the segment.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A diamond tool comprising:
a shank having an outer peripheral region;
a cutting segment adjacent the outer peripheral region of the shank, the cutting segment including a plurality of diamond granules, and an auxiliary cutting portion having a thickness substantially identical to the thickness of the shank and a height, the auxiliary cutting portion being adjacent the shank, the cutting segment also including a primary cutting portion adjacent the auxiliary cutting portion, the primary cutting portion having a thickness larger than that of the auxiliary cutting portion.

2. The diamond tool as claimed in claim 1, wherein the auxiliary and primary cutting portions are connected to each other in a stepped fashion.

3. The diamond tool as claimed in claim 1, wherein a connection surface between the auxiliary and primary cutting portions comprises a curved surface or a slant surface.

4. The diamond tool as claimed in claim 1, wherein the height of the auxiliary cutting portion is in a range of 0.8 to 3 mm.

5. The diamond tool as claimed in claim 1, wherein a difference between the thicknesses of lower ends of the auxiliary and primary cutting portions is not less than 0.2 mm.

6. The diamond tool as claimed in claim 5, wherein the auxiliary cutting portion is provided, at an outer side thereof, with a wear region having a height and a thickness to be flush with an outer surface of the primary cutting portion.

7. The diamond tool as claimed in claim 6, wherein the wear region is a region without diamond granules.

8. The diamond tool as claimed in claim 6, wherein the height of the wear region is in a range of 0.8 to 3 mm.

9. A method for manufacturing a segment of a diamond tool, the segment including an auxiliary cutting portion to be attached to a shank and a primary cutting portion integrally formed adjacent the auxiliary cutting portion, the method comprising the steps of:
mixing diamond granules with a binder;
forming a segment pre-form by press-molding the mixture of diamond granules and binder within molds having a predetermined shape so that the auxiliary cutting portion has a thickness substantially corresponding to a thickness of the shank and the primary cutting portion has a thickness larger than the thickness of the auxiliary cutting portion; and
sintering the segment pre-form to obtain a final product.

10. The method as claimed in claim 9, wherein each of the molds has a lower end protruding in a stepped fashion.

11. The method as claimed in claim 9, wherein each of the molds has a lower end protruding in a curved or slant fashion.

12. A method for manufacturing a segment of a diamond tool, the segment including an auxiliary cutting portion to be attached to a shank and a primary cutting portion integrally formed adjacent the auxiliary cutting portion, the method comprising the steps of:
preparing a segment pre-form such that diamond granules arranged in a binder constituting the auxiliary cutting portion are arranged to establish a thickness substantially corresponding to a thickness of the shank, and diamond granules arranged in a binder constituting the primary cutting portion are arranged to establish a thickness larger than the thickness of the auxiliary cutting portion; and
sintering the segment pre-form to obtain a final product.

13. The method as claimed in claim 12, wherein the step of arranging the diamond granules comprises arranging the diamond granules to have a stepped portion substantially corresponding to the auxiliary and primary cutting portions.

14. The method as claimed in claim 12, wherein the step of arranging the diamond granules comprises arranging the diamond granules such that the auxiliary and primary cutting portions are connected to each other in a curved or slant fashion.

15. The method as claimed in claim 9, wherein the diamond granules are distributed uniformly or non-uniformly.

16. The diamond tool as claimed in claim 1, wherein the auxillary cutting portion is fixedly attached to the outer peripheral region thereof

17. The diamond tool as claimed in claim 1, wherein the primary cutting portion is integrally formed with the auxiliary cutting portion.
